(19) United States
(12) Patent Application Publication
(10) Pub. No.: US 2010/0090941 A1
(43) Pub. Date: Apr. 15, 2010

(54) LIQUID CRYSTAL DISPLAY

(76) Inventors: Hyun-Jin KIM, Youngin-si (KR); Seok-Hyun Nam, Seoul (KR); Sang-Hyuck Yoon, Seoul (KR); Kyung-Min Kim, Asan-si (KR)

Correspondence Address: Innovation Counsel LLP, 21771 Stevens Creek Blvd, Ste. 200A, Cupertino, CA, 95014, US

(21) Appl. No.: 12/566,567

(22) Filed: Sep. 24, 2009

(30) Foreign Application Priority Data
Oct. 9, 2008 (KR) 10-2008-0099178

(51) Int. Cl. G09G 3/36; G02F 1/13357

(52) U.S. Cl. 345/102; 349/70

(57) ABSTRACT

A liquid crystal display (LCD) may include in accordance with one or more embodiments an LCD panel on which an image is displayed and a fluorescent lamp providing light to the LCD panel. A tube current having a duty ratio may be applied to the fluorescent lamp. The duty ratio of the tube current may increase gradually from an initial duty ratio to a final duty ratio during a transition interval.

### CROSS-REFERENCE TO RELATED APPLICATION

This application claims priority to and benefit from Korean Patent Application No. 10-2008-0099178 filed on Oct. 9, 2008 in the Korean Intellectual Property Office, the disclosure of which is incorporated herein by reference in its entirety.

### BACKGROUND

1. Technical Field

The present disclosure relates generally to a liquid crystal display (LCD), and more particularly, to an LCD, which for example may be capable of reducing a malfunction of a remote controller.

2. Related Art

A liquid crystal display (LCD) may include a liquid crystal panel including a first panel having pixel electrodes, a second panel having a common electrode, and a liquid crystal layer interposed therebetween. A voltage is applied between the two electrodes to generate an electric field across the liquid crystal layer having dielectric anisotropy. The amplitude of the electric field across the liquid crystal layer controls the transmittance of light passing through the liquid crystal layer. When each of the plurality of pixels has an electric field corresponding to a pixel, the LCD implements a desired image.

Recently, LCDs have suffered from malfunctions of remote controllers. The main problem reported is that LCDs and peripheral devices fail to respond properly to manipulation of remote controllers for a considerable period of time after power is applied. For example, with the growing popularity of home theater systems, a frequent complaint is that remote controllers fail to operate LCD-TVs and their peripheral devices such as DVD players.

One of the main causes of malfunctions of a remote controller is attributed to infrared light generated by a fluorescent lamp used as a light source providing light to a liquid crystal panel. That is, infrared light containing the same wavelength as an infrared control signal emitted by the remote controller may cause the remote controller to malfunction since it suffers from interference with the infrared control signal.

### SUMMARY

The present disclosure provides a liquid crystal display (LCD), which may be configured to reduce the malfunction of a remote controller in accordance with one or more embodiments.

Specifically, these and other aspects of the disclosure will be described in or be apparent from the following description of embodiments.

In accordance with one or more embodiments, there is provided a liquid crystal display (LCD) including an LCD panel on which an image is displayed; and a fluorescent lamp providing light to the LCD panel, wherein a tube current having a duty ratio is applied to the fluorescent lamp, wherein the duty ratio of the tube current increases gradually from an initial duty ratio to a final duty ratio during a transition interval.

In accordance with one or more embodiments, there is provided a liquid crystal display (LCD) including an infrared sensor adapted to detect an infrared control signal received from an external circuit; an LCD panel on which an image is displayed; and a fluorescent lamp providing light to the LCD panel, wherein a duty ratio of a tube current being applied to the fluorescent lamp is adjusted according to an amount of noise detected by the infrared sensor.

In accordance with one or more embodiments, there is provided a liquid crystal display (LCD) including an infrared sensor adapted to detect an infrared control signal received from an external circuit; an LCD panel on which an image is displayed; and a fluorescent lamp providing light to the LCD panel, wherein upon detection of infrared light having a wavelength close to a wavelength of the infrared control signal for more than a preset duration of time, the detected infrared light is recognized as noise.

### BRIEF DESCRIPTION OF THE DRAWINGS

The above and other features and aspects of the present disclosure will become more apparent by describing in detail embodiments thereof with reference to the attached drawings in which:

FIG. 1 is a conceptual diagram for explaining a liquid crystal display (LCD) in accordance with one or more embodiments;

FIG. 2 is a block diagram of the LCD of FIG. 1 in accordance with one or more embodiments;

FIG. 3 is an equivalent circuit diagram of a pixel PX in the liquid crystal panel shown in FIG. 2 in accordance with one or more embodiments;

FIG. 4 is a block diagram of the image signal controller shown in FIG. 2 in accordance with one or more embodiments;

FIG. 5 is a block diagram of the optical data signal controller shown in FIG. 2 in accordance with one or more embodiments;

FIG. 6 is a timing diagram for explaining an optical data signal shown in FIG. 5 in accordance with one or more embodiments;

FIG. 7 is a conceptual diagram for explaining the operation of the backlight driver and the fluorescent lamp shown in FIG. 2 in accordance with one or more embodiments;

FIG. 8 is a signal waveform diagram for explaining a duty ratio of a tube current shown in FIG. 7 in accordance with one or more embodiments;

FIG. 9 is a diagram illustrating the spectrum of infrared light generated by the fluorescent lamp (FL) shown in FIG. 1 according to a conventional example;

FIG. 10 is a diagram illustrating an enlarged spectrum of a portion B of the overall spectrum of FIG. 9 in accordance with one or more embodiments;

FIG. 11 illustrates a duty ratio of a tube current used in an experimental example according to one or more embodiments of the present disclosure;

FIG. 12 is a spectrum diagram illustrating an increase in the intensity of infrared light generated by a fluorescent lamp in an experimental example using the duty ratio of the tube current illustrated in FIG. 11 in accordance with one or more embodiments, as compared to a conventional example;

FIG. 13 is a graph illustrating a decrease of overshoots in a brightness in an experimental example using the duty ratio of the tube current illustrated in FIG. 11 in accordance with one or more embodiments, compared to a conventional example;

FIG. 14 illustrates various examples of multiplication factors for explaining a duty ratio of a tube current applied to a fluorescent lamp in an LCD according to one or more embodiments of the present disclosure;

FIG. 15 is a block diagram of an LCD according to one or more embodiments of the present disclosure;

FIG. 16 is a block diagram of the infrared sensing unit shown in FIG. 15 in accordance with one or more embodiments;

FIG. 17 is a block diagram of the optical data signal controller shown in FIG. 15 in accordance with one or more embodiments; and

FIG. 18 is a timing diagram for explaining an optical data signal illustrated in FIG. 15 in accordance with one or more embodiments.

### DETAILED DESCRIPTION

Advantages and features of embodiments of the present invention, including methods of accomplishing the same, may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

It will be understood that when an element or layer is referred to “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure relates. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

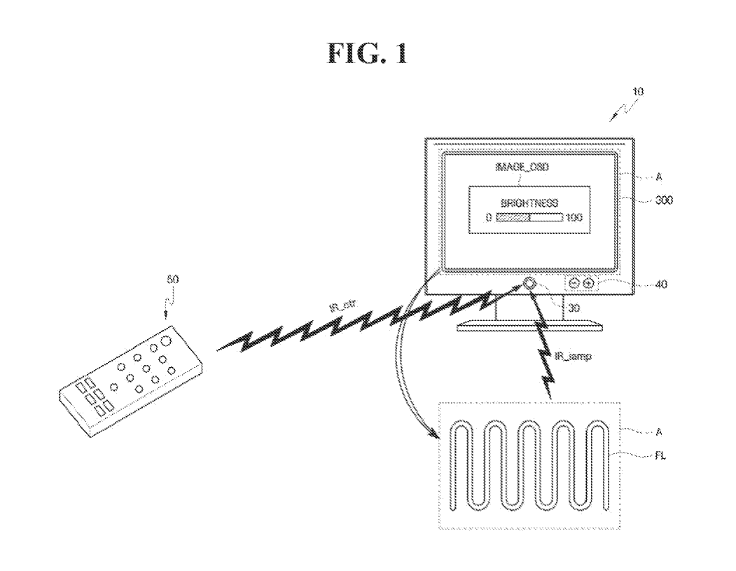

Hereinafter, liquid crystal displays (LCDs) according to embodiments of the present disclosure will be described in detail with reference to FIGS. 1 through 13.

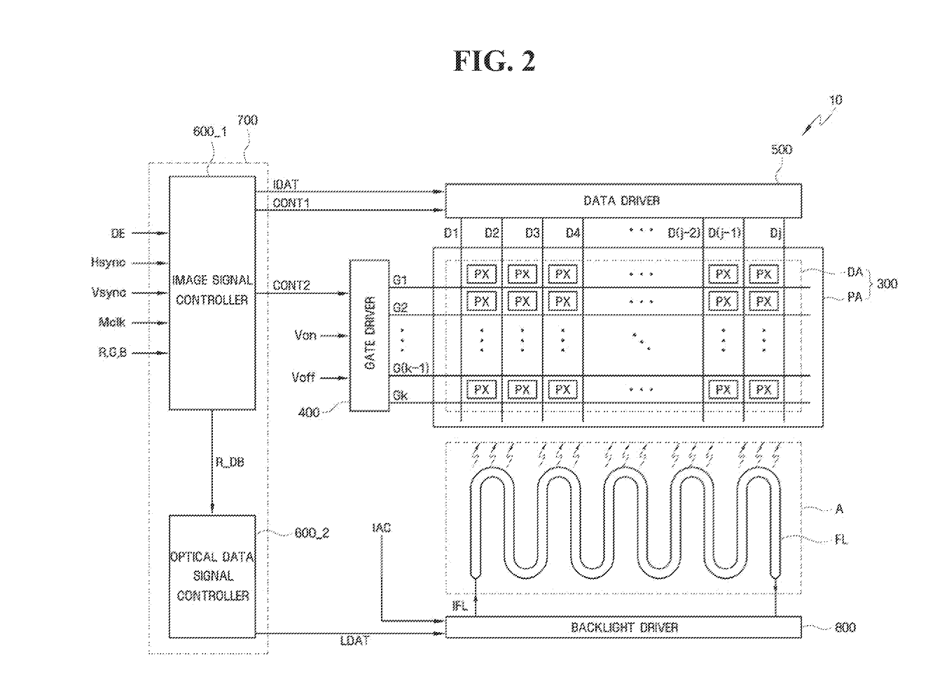

FIG. 1 is a conceptual diagram for explaining a liquid crystal display (LCD) according to one or more embodiments of the present disclosure, and FIG. 2 is a block diagram of the LCD of FIG. 1 in accordance with one or more embodiments.

Referring to FIGS. 1 and 2, one or more embodiments of an LCD 10 may include an LCD panel 300 having a display area (DA) for displaying an image and a peripheral area (PA) as a non-display area surrounding the display area DA, a user handling portion 40, a remote controller 50, an infrared sensing unit having an infrared sensor 30, a fluorescent lamp (FL), a signal control unit 700, a gate driver 400, a data driver 500, and a backlight driver 800.

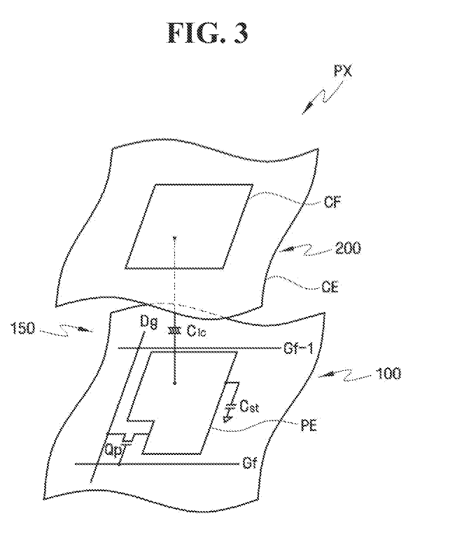

The LCD panel 300 may include a plurality of gate lines G1-Gk, a plurality of data lines D1-Dj, and a plurality of pixels PX. The respective pixels PX may be defined at intersections of the gate lines G1-Gk and the data lines D1-Dj. Although not shown, the plurality of pixels PX may be divided into red sub-pixels, green sub-pixels, and blue sub-pixels. Each pixel PX will later be described with reference to FIG. 3.

The LCD panel 300 may include a display area DA receiving light from a fluorescent lamp FL and displaying an image and a peripheral area PA, i.e., a non-display area. The display area DA may include a plurality of pixels PX each displaying an image in response to an image data voltage supplied from the data driver 500. In the peripheral area PA, the first substrate (100 of FIG. 3) may be wider than the second substrate (200 of FIG. 3), and an image may not be displayed on the peripheral area PA. The LCD panel 300 may also display an On Screen Display (OSD) image IMAGE_OSD in response to manipulation of the user handling portion 40 or the remote controller 50.

As shown in FIG. 1, the user handling portion 40 may include buttons on a front surface of the LCD and may generate a user command signal in response to handling. For example, upon the user pressing a button in the user handling portion 40 in order to adjust the brightness or contrast of the LCD 10, an OSD image IMAGE_OSD corresponding thereto may be displayed on the LCD panel 300. The OSD image IMAGE_OSD allows the user to more easily operate the LCD 10.

The remote controller 50 may send an infrared control signal IR_ctr in response to user manipulation. The infrared control signal IR_ctr may contain information about a command generated by manipulating the remote controller 50. In this case, like in manipulating the user handling portion 40, an OSD image IMAGE_OSD corresponding to manipulation of the remote controller 50 may be displayed on the LCD panel 300.

The infrared sensor 30 in the Infrared sensing unit may detect an infrared control signal IR_ctr received from an external circuit, such as the remote controller 50. When the infrared sensor 20 senses the infrared control signal IR_ctr, the operation of the LCD 10 may be controlled in response to the infrared control signal IR_ctr. For example, upon pressing a power button of the remote controller 50 in order to turn on the LCD 10, the remote controller 50 may send an infrared control signal corresponding to the action of pressing the power button. When the infrared sensor 30 detects the infrared control signal IR_ctr, the LCD may be turned on in response to the infrared control signal IR_ctr.

The fluorescent lamp FL may provide light to the LCD panel 300. The fluorescent lamp FL may be disposed on an area A indicated by dotted lines, for example, on a rear surface of the LCD panel 300. For example, the fluorescent lamp FL may be a Cold Cathode Fluorescent Lamp (CCFL).

The fluorescent lamp FL may comprise a vacuum-sealed glass tube filled with mercury (Hg) and argon (Ar). When a tube current IFL is applied to the fluorescent lamp FL, Hg may be discharged to produce light. In this case, Ar facilitates an Hg discharge. A discharge refers to a phenomenon in which an insulator loses the insulation property under a strong electric field and electric current passes through the insulator. Ultraviolet radiation produced by an Hg discharge may excite a fluorescent material applied on the inside of the glass tube to emit visible rays.

Upon application of the tube current IFL to the fluorescent lamp FL, the fluorescent lamp FL may be heated to vaporize Hg and Ar therein. As the Hg vaporizes, it may absorb energy emitted by vaporizing Ar. A part of the energy not absorbed during vaporization of Hg may be converted into a lamp infrared ray IR_lamp for emission.

The emitted lamp infrared ray IR_lamp may contain a wavelength component near 900 nm coincident with a wavelength of the infrared control signal IR_ctr. Thus, the lamp infrared ray IR_lamp may interfere with the infrared control signal IR_ctr generated by the remote controller 50, thereby causing the remote controller 50 to malfunction. That is, the lamp infrared ray IR_lamp may act as noise relative to the infrared control signal IR_ctr.

An optical sheet having an infrared filter function may be used to reduce the malfunction of the remote controller 50. However, the optical sheet may also reduce the brightness while increasing the manufacturing costs. Alternatively, to achieve the same purpose, the amount of Ar filled into the fluorescent lamp FL may be reduced since most of the lamp infrared rays IR_lamp containing a wavelength coincident with the wavelength of the infrared control signal IR_ctr are emitted during vaporization of Ar. However, this approach may have a drawback in that it may reduce the efficiency and lifetime of the fluorescent lamp FL.

More specifically, Ar may increase the efficiency of the fluorescent lamp FL by lowering a discharge start voltage. That is, although hot electrons emitted from a filament of the fluorescent lamp FL may directly ionize Hg atoms, it may be more energy efficient for electrons emitted following ionization of Ar atoms to ionize Hg atoms, which may be called a penning effect. Further, since the amount of Ar consumed may increase as the fluorescent lamp FL is used for a longer period of time, the lifetime of the fluorescent lamp FL may decrease as the amount of Ar decreases.

In the LCD 10 according to the present embodiment, the fluorescent lamp FL may be a low-pressure lamp such as a low gas pressure, high efficiency CCFL being currently developed. However, the amount of Ar contained in the CCFL may be absolutely insufficient, thus resulting in a reduction in efficiency and lifetime of the CCFL. To overcome these problems, the amount of Ar may be increased by increasing the percentage of Ar in the mixture. Increasing the amount of Ar may, however, increase the amount of lamp infrared ray IR_lamp containing a wavelength coincident with the wavelength of the infrared control signal IR_ctr, thereby worsening the malfunction problem with the remote controller 50.

Despite use of a low pressure lamp such as the fluorescent lamp FL, the LCD 10 according to the present embodiment may be configured to reduce the malfunction of the remote controller 50.

The signal controller 700 may be supplied with first image signals R, G, and B and external control signals Vsync, Hsync, Mclk, and DE controlling the display thereof from an external graphics controller. On the basis of the external control signals Vsync, Hsync, Mclk, and DE and the first image signals R, G, and B, the signal controller 700 may adequately process these signals and generate second image signals IDAT, gate control signals CONT1, data control signals CONT2, and light data signals LDAT. For example, the signal controller 700 may convert the first image signals R, G, and B into the second image signals IDAT and may generate the same. The signal controller 700 may transmit the light data signals LDAT to the backlight driver 800.

The signal controller 700 may be functionally divided into an image signal control unit 600_1 and a light data signal control unit 600_2. The image signal control unit 600_1 may control the image displayed on the LCD panel 300, while the light data signal control unit 600_2 may control the operation of the backlight driver 800. The image signal control unit 600_1 and the light data signal control unit 600_2 may be physically separated from each other.

In one or more embodiments, the image signal control unit 600_1 receives a first image signal R, G, B and outputs a second image signal IDAT corresponding to the received first image signal R, G, B. The image signal control unit 600_1 may also receive external control signals Vsync, Hsync, Mclk, and DE, and generate a data control signal CONT1 and a gate control signal CONT2. Examples of the external control signals Vsync, Hsync, Mclk, and DE may include a vertical synchronization signal Vsync, a horizontal synchronization signal Hsync, a main clock signal MCLK, and a data enable signal DE. The data control signal CONT1 may be used to control the operation of the data driver 500, and the gate control signal CONT2 may be used to control the operation of the gate driver 400.

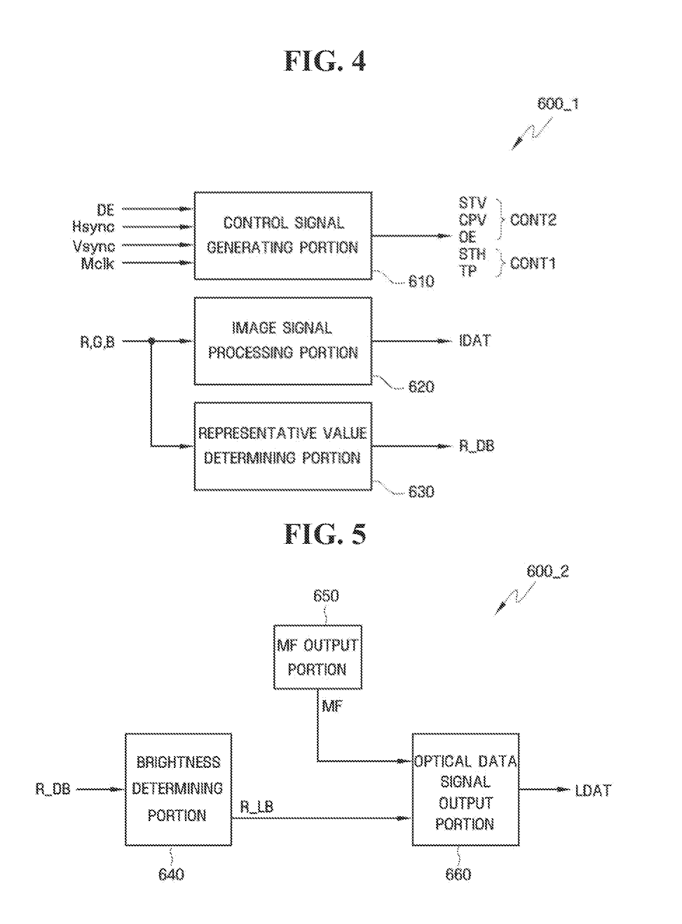

In addition, the image signal control unit 600_1 may receive the first R, G, and B image signal R, G, and B, output a representative image signal R_DB, and supply the same to the light data signal control unit 600_2. The image signal control unit 600_1 will be described below in more detail with reference to FIG. 4.

The light data signal control unit 600_2 may receive the representative image signal R_DB and the back light luminance level IL and may supply a light data signal LDAT to the backlight driver 800. The light data signal control unit 600_2 will be described below in more detail with reference to FIG. 5.

The gate driver 400, which may be provided with the gate control signal CONT2 from the image signal control unit 600_1, may apply a gate signal to the gate lines G1-Gk. The gate signal may be composed of a combination of a gate-on voltage Von and a gate-off voltage Voff, which may be generated from a gate on/off voltage generator (not shown). The gate control signal CONT2 for controlling the operation of the gate driver 400 may include a vertical synchronization start signal instructing start of the operation of the gate driver 400, a gate clock signal controlling an output timing of the gate on signal, an output enable signal that determines a pulse width of the gate-on voltage Von, etc.

The data driver 500 may receive the data control signal CONT1 from the image signal control unit 600_1 and may apply a voltage corresponding to the second image signal IDAT to the data lines D1-Dj. The voltage corresponding to the second image signal IDAT may be a voltage supplied from a gray voltage generator (not shown) according to grayscales of the second image signal IDAT. That is to say, the voltage may be obtained by dividing a driving voltage of the gray voltage generator according to the grayscales of the grayscales of the second image signal IDAT. The data control signal CONT1 may include signals for controlling the operation of the data driver 500. The signals for controlling the operation of the data driver 500 may include a horizontal synchronization start signal for starting the operation of the data driver 500, an output enable signal that determining the output of an image data voltage, etc.

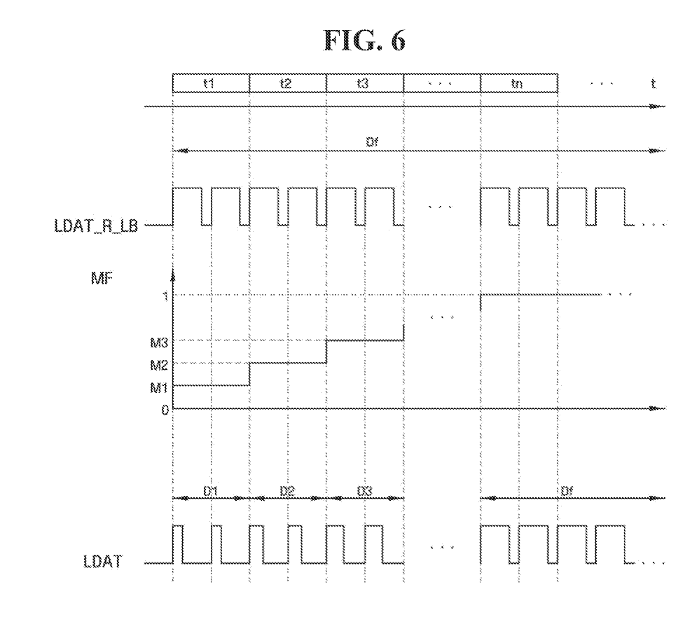

The backlight driver 800 may adjust the amount of the tube current IFL being applied to the fluorescent lamp FL in response to optical data signal LDAT. More specifically, the backlight driver 800 may receive an alternating current IAC and an optical data signal LDAT from an alternating power generator (not shown) and the optical data signal controller 600_2, respectively, in order to provide the tube current IFL to the fluorescent lamp FL. The backlight driver 800 may control a duty ratio of the alternating current IAC according to a duty ratio of the optical data signal LDAT. The amount of the alternating current IAC may vary with the duty ratio thereof. Adjustment in the amount of the tube current IFL by the backlight driver 800 will be described in more detail later with reference to FIGS. 6 through 8. FIG. 3 is an equivalent circuit diagram of a pixel PX in the LCD panel shown in FIG. 2.

Referring to FIG. 3, a pixel PX connected to an f-th gate line Gf (where f is 1 through k) and a g-th data line Dg (where g is from 1 through j) may include a switching element Qp connected to the gate line Gf and the data line Dg, a liquid crystal capacitor Clc, and a storage capacitor Cst connected thereto. The liquid crystal capacitor Clc may include two electrodes, for example, a pixel electrode PE of a first substrate 100, a common electrode CE of a second substrate 200, and liquid crystal molecules 150 interposed between the first and second substrates 100 and 200. A color filter CF may be formed at a portion of the common electrode CE.

FIG. 4 is a block diagram of the image signal controller shown in FIG. 2 in accordance with an embodiment.

Referring to FIG. 4, an image signal controller 600_1 may include a control signal generating portion 610, an image signal processing portion 620, and a representative value determining portion 630.

The control signal generating portion 610 may receive the external control signals Vsync, Hsync, Mclk, and DE and may output the data control signal CONT1 and the gate control signal CONT2. For example, the control signal generating portion 610 may generate various signals, such as a vertical start signal STV for starting the operation of the gate driver 400 shown in FIG. 2, a gate clock CPV for determining an output time of the gate-on voltage Von, a gate output enable signal OE for determining a pulse width of the gate-on voltage Von, a horizontal synchronization start signal STH for starting the operation of the data driver 500 as shown in FIG. 2, and an output instruction signal TP for instructing the output of an image data voltage.

The image signal processor 620 may receive first image signals R, G, and B and may output second image signals IDAT corresponding to the received first image signals R, G, and B. The second image signals IDAT may be signals converted from the first image signals R, G, and B for improving display quality, for example, overdriving. A detailed explanation about the operation of overdriving will not be given herein, but would be understood by one skilled in the art.

The representative value determiner 630 may determine a representative image signal R_DB displayed on the LCD panel 300. For example, the representative value determiner 630 may receive the first image signals R, G, and B and determine the representative image signal R_DB. The representative image signal R_DB may be an average value of the first image signals R, G, and B. Thus, the representative image signal R_DB may indicate an average luminance value of the image displayed on the LCD panel 300.

FIG. 5 is a block diagram of the optical data signal controller shown in FIG. 2, and FIG. 6 is a timing diagram for explaining an optical data signal shown in FIG. 5 in accordance with one or more embodiments.

Referring to FIGS. 5 and 6, an optical data signal controller 6002 may include a brightness determining portion 640, a multiplication factor output portion 650, and an optical data signal output portion 660. The brightness determining portion 640 may receive a representative image signal R_DB to determine a native brightness R_LB of a backlight corresponding to the representative image signal R_DB and outputs the native brightness R_LB of the backlight to the optical data signal output portion 660. For example, the brightness determining portion 640 may determine the native brightness R_LB of the backlight using a look-up table (not shown).

The multiplication factor output portion 650 may output a multiplication factor MF to be multiplied by a duty ratio corresponding to the native brightness R_LB of the backlight. The multiplication factor MF may be preset by the manufacturer or have a value that increases from an initial value between 0 and 1 to a final value of 1.

As shown in FIG. 6, multiplication factor MF may have different values M1 through 1 for each time interval (t1 through tn). That is, the multiplication factor MF increases stepwise to 1 with increasing time intervals. The time to reach the final value of 1 may be greater than 10 seconds, in particular, greater than 30 seconds.

The optical data signal output portion 660 receives the native brightness R_LB of the backlight and the multiplication factor MF to output the optical data signal LDAT. More specifically, the optical data signal output portion 660 may receive the native brightness R_LB of the backlight to determine a duty ratio and may output the optical data signal LDAT having a duty ratio derived by multiplying the multiplication factor MF by the determined duty ratio.

In FIG. 6, LDAT_R_LB denotes an optical data signal having a duty ratio corresponding to the native brightness R_LB of the backlight. Df and LDAT respectively denote a duty ratio of the optical data signal that may be determined according to the native brightness R_LB of the backlight and an optical data signal having a duty ratio derived by multiplying the multiplication factor MF.

Referring to FIG. 6, a duty ratio of the optical data signal LDAT may have values D1 through Df that increase stepwise with time. More specifically, the optical data signal LDAT may have different duty ratios for each time interval since a duty ratio of the optical data signal LDAT may be obtained at each time interval by multiplying a varying multiplication factor by the duty ratio Df of the optical data signal LDAT_R_LB that may be determined according to the native brightness R_LB of the backlight. D1 and Df are hereinafter referred to as an initial duty ratio and a final duty ratio, respectively. Duty ratios (D1, D2, D3, . . . ) between the initial and final duty ratios D1 and Df are hereinafter called transition duty ratios.

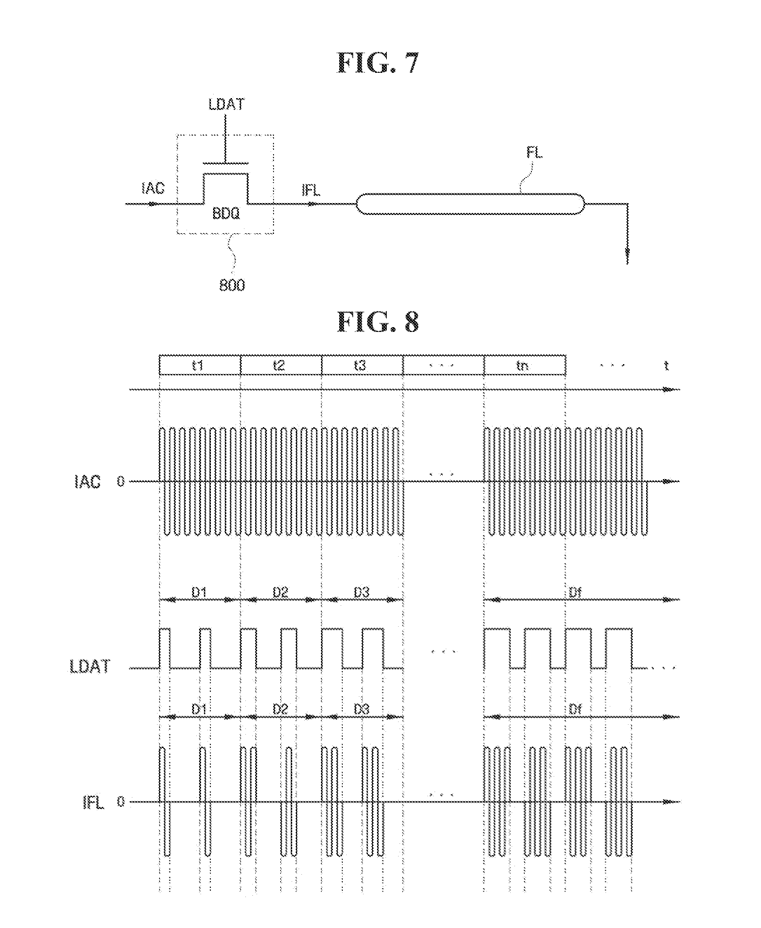

FIG. 7 is a conceptual diagram for explaining the operation of the backlight driver and the fluorescent lamp shown in FIG. 2, and FIG. 8 is a signal waveform diagram for explaining a duty ratio of a tube current shown in FIG. 7 in accordance with one or more embodiments.

Referring to FIGS. 7 and 8, the backlight driver 800 receives alternating current IAC from the alternating power generator and provides the tube current IFL to the fluorescent lamp FL in response to an optical data signal LDAT that may be a control signal. The backlight driver 800 may include a three-terminal (triode) switching device BDQ having an input terminal to which alternating current IAC may be applied, a control terminal to which optical data signal LDAT may be applied, and an output terminal from which the tube current IFL may be output. When the optical data signal LDAT has a relatively high level, the switching device BDQ is turned on. When the optical data signal LDAT has a relatively low level, the switching device BDQ may be turned off. That is, the duration of time during which the switching device BDQ is turned on can be adjusted according to a duty ratio of the optical data signal LDAT.

As shown in a signal waveform diagram of FIG. 8, the alternating current IAC may have a constant frequency. When the alternating current IAC has a duty ratio of 1, the tube current IFL may have the same duty ratio as the optical data signal LDAT since the duration of time during which the switching device BDQ is turned on may be adjusted according to the duty ratio of the optical data signal LDAT. Consequently, because the amount of the tube current IFL is proportional to the duty ratio of the tube current IFL, the amount of the tube current IFL being applied to the fluorescent lamp FL can be controlled according to the duty ratio of the optical data signal LDAT. In the LCD 10 according to the present embodiment, a duty ratio of the tube current IFL may include transition intervals during which the duty ratio increases gradually from an initial duty ratio to a final duty ratio.

As described above with reference to FIG. 6, the optical data signal LDAT may have different duty ratios for each time interval that increase stepwise to the final value by passing through at least one transition interval in the duty ratio. Thus, the tube current IFL may also have a duty ratio that increases in a stepwise manner by passing through at least one transition interval in the duty ratio. The duty ratio of the tube current IFL may include transition intervals during which it increases from the initial duty ratio D1 to the final duty ratio Df. As a result, the amount of the tube current IFL can increase in a stepwise manner while passing through at least one transition interval.

FIG. 8 shows the ratio of the initial duty ratio D1 to the final duty ratio Df is 10% to 60%, in particular, less than 50%. The duration of time to reach the final duty ratio Df from the initial duty ratio D1 that is an initial value of transition duty ratios may be greater than 10 seconds, in particular, greater than 30 seconds.

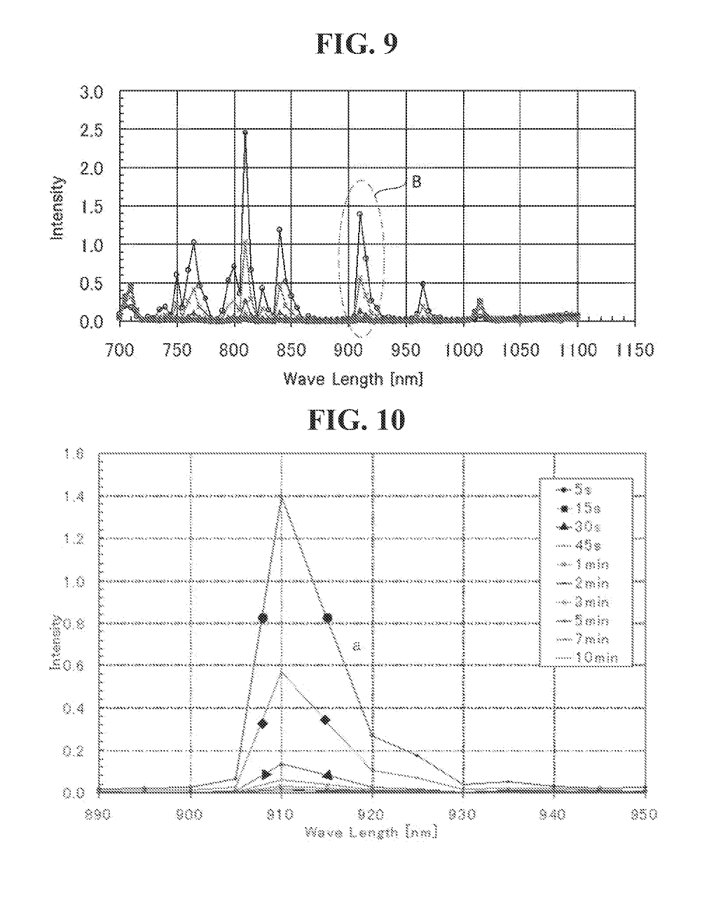

FIG. 9 is a diagram illustrating the spectrum of infrared light generated by the fluorescent lamp FL shown in FIG. 1 according to a conventional example, and FIG. 10 is a diagram illustrating an enlarged spectrum of a portion B of the overall spectrum of FIG. 9 in accordance with one or more embodiments.

According to a conventional example that is compared against an example embodiment of the present disclosure, tube current IFL may have an initial duty ratio D1 that may be equal to the final duty ratio Df. FIGS. 9 and 10 illustrate a spectrum of long-wavelength infrared light over time, which may be emitted by the fluorescent lamp FL.

Referring to FIGS. 9 and 10, when tube current IFL having the final duty ratio Df is applied to the fluorescent lamp FL upon starting the drive of an LCD, lamp infrared ray IR_lamp contains a considerable number of wavelength components near 900 nm (a wavelength range indicated by B in FIG. 9). Since a wavelength component near 900 nm may be coincident with a wavelength of the infrared control signal (IR_ctr in FIG. 1), it may act as noise with respect to the infrared control signal, thereby causing malfunctions of a remote controller.

As illustrated in FIGS. 9 and 10, the intensity of a wavelength component near 900 nm has a peak within 30 seconds (5 s, 10 s, and 30 s) after start-up 10 times higher than after 30 seconds (45 s, 1 min, . . . 10 min). Thus, the LCD 10 may suffer severe malfunction of the remote controller 50 during initial driving.

In the LCD 10 according to the present embodiment, the duty ratio of the tube current IFL increases as the temperature of the fluorescent lamp FL rises. With the lapse of time during which the tube current IFL is applied to the fluorescent lamp FL, the temperature of the fluorescent lamp FL increases together with the amount of Hg vaporized. Thus, as the amount of Hg vaporized increases, the duty ratio of the tube current IFL increases.

The amount of energy emitted during vaporization of Ar also increases with the duty ratio of the tube current IFL. Since the duty ratio of the tube current IFL can increase with the amount of Hg vaporized as described above, the amount of Hg vaporized can be increased in proportion to the amount of energy emitted during vaporization of Ar. Thus, Hg can absorb a sufficient amount of the energy emitted during the vaporization of Ar, thereby reducing the amount of energy that will be converted into lamp infrared ray IR_lamp due to failure to absorb the energy as Hg vaporizes.

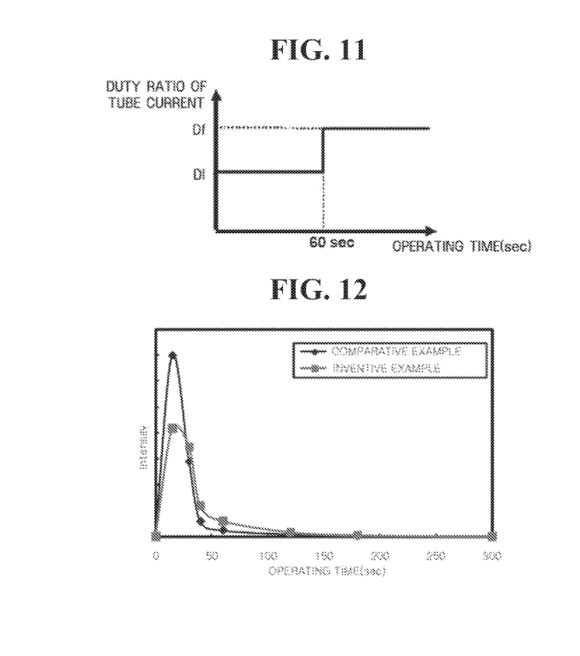

FIG. 11 illustrates a duty ratio of a tube current used in an experimental example in accordance with one or more embodiments of the present disclosure. Referring to FIG. 11, in the experimental example, the ratio of the initial duty ratio D1 to the final duty ratio Df may be 50%. The duration of time to reach the final duty ratio Df from the initial duty ratio D1 may be 60 seconds.

FIG. 12 is a spectrum diagram illustrating an increase in the intensity of infrared light generated by a fluorescent lamp in an experimental example embodiment using the duty ratio of a tube current illustrated in FIG. 11, as compared to a conventional example. FIG. 12 illustrates a reduction in the intensity of a wavelength component near 900 nm for an experimental example embodimentin comparison with a conventional example. As illustrated in FIG. 12, a peak of the wavelength component near 900 nm may be reduced by more than 40%.

The LCD 10 according to the present embodiment may be configured such that the initial amount of lamp infrared light IR_lamp emitted from the fluorescent lamp FL can be reduced by decreasing the amount of tube current IFL being applied to the fluorescent lamp FL when it is initially driven. Thus, the likelihood of malfunction of the remote controller 50 may be reduced.

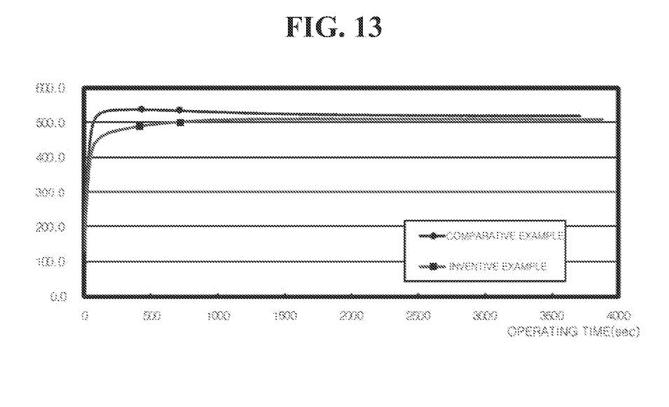

FIG. 13 is a graph illustrating a decrease of overshoots in brightness in one or more example embodiments using the duty ratio of a tube current illustrated in FIG. 11, compared to a conventional example.

According to a conventional example shown in FIG. 13, upon initially driving an LCD, tube current IFL having a high initial value is applied to the fluorescent lamp FL in order to increase the amount of Hg vaporized. However, despite application of initial high tube current IFL, Hg cannot absorb a sufficient amount of energy emitted from the vaporization of Ar due to a restriction on the rate of vaporization of Hg. Thus, a part of the energy not absorbed may be converted into lamp infrared ray IR_lamp for emission, which may cause a malfunction of a remote controller.

Application of the initial high tube current IFL may also cause an overshoot in brightness as shown in FIG. 13, which may result in excessive power consumption. A conventional LCD that can be manufactured based on a maximum consumption power available during overshoot may require a power supply that can safely withstand the overshoot, thereby resulting in higher manufacturing costs. However, according to an example embodiment shown in FIG. 13, overshoot may not occur, unlike in the prior art example. Thus, an LCD according to one or more embodiments may use a power supply that can sustain low power consumption, which may reduce manufacturing costs.

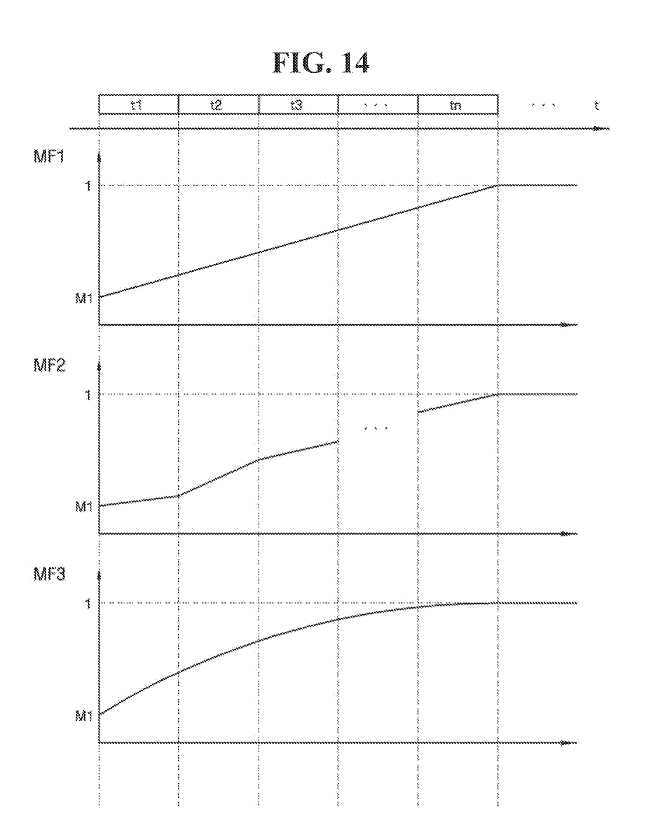

An LCD according to one or more embodiments will be described with reference to FIG. 14. Like elements having the substantially same functions as in the previous embodiment are denoted by like numbers. Thus, a detailed description of the functions will not be given to avoid redundancy.

FIG. 14 illustrates various examples of multiplication factors for explaining the duty ratio of a tube current applied to a fluorescent lamp in an LCD in accordance with one or more embodiments.

Referring to FIG. 14, multiplication factor MF may show a continuous and monotonous or steady increase. MF1 represents one or more embodiments in which multiplication factor MF continuously, monotonously, or steadily increases in the form of a straight line having a single gradient. MF2 represents an example in which multiplication factor MF monotonously increases in the form of a straight line having different gradients for each time interval. MF3 represents an example in which multiplication factor MF monotonously or steadily increases in the form of a continuous curve. A duration of time during which the multiplication factor MF increases from an initial value M1 to a final value of 1 may be greater than 10 seconds, in particular, greater than 30 seconds.

Thus, a duty ratio of optical data signal LDAT may show a continuous, steady, and monotonous increase with time. Accordingly, a duty ratio of tube current IFL may increase continuously, steadily, and monotonously with increasing duty ratio of the optical data signal LDAT.

In the LCD according to the present embodiment, the duty ratio of the tube current IFL may increase with increasing temperature of the fluorescent lamp FL. Further, the duty ratio of the tube current IFL may increase as the amount of Hg vaporized increases.

Thus, since the amount of Hg vaporized may be increased in proportion to the amount of energy emitted during vaporization of Ar, Hg may absorb a sufficient amount of the energy emitted during the vaporization of Ar, which may reduce the amount of energy converted into lamp infrared ray IR_lamp due to non-absorption of the energy. Thus, the initial amount of lamp infrared light IR_lamp emitted from the fluorescent lamp FL may be reduced by decreasing the amount of tube current IFL being applied to the fluorescent lamp FL when the LCD is initially driven, which may reduce the likelihood of malfunction of a remote controller.

Another advantage may be that since overshoot does not occur like in the embodiment described with reference to FIGS. 1 through 13, the LCD according to the present embodiment may use a power supply that can sustain low power consumption, which may reduce manufacturing costs.

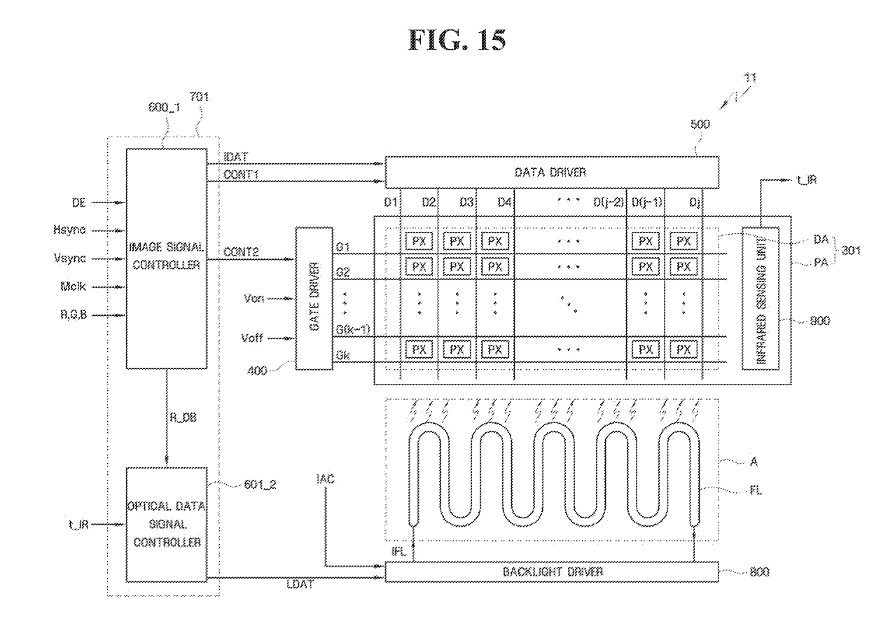

An LCD 11 in accordance with one or more embodiments is described in more detail with reference to FIGS. 15 through 18. Like elements having the substantially same functions as in the previous embodiments are denoted by like numbers. Thus, a detailed description of the functions is omitted to avoid redundancy.

FIG. 15 is a block diagram of an LCD in accordance with one or more embodiments.

Referring to FIG. 15, the LCD 11 may include an LCD panel 301 having a display area DA for displaying an image and a non-display area PA having an infrared sensing unit 900, a fluorescent lamp FL, a signal control unit 701, a gate driver 400, a data driver 500, and a backlight driver 800.

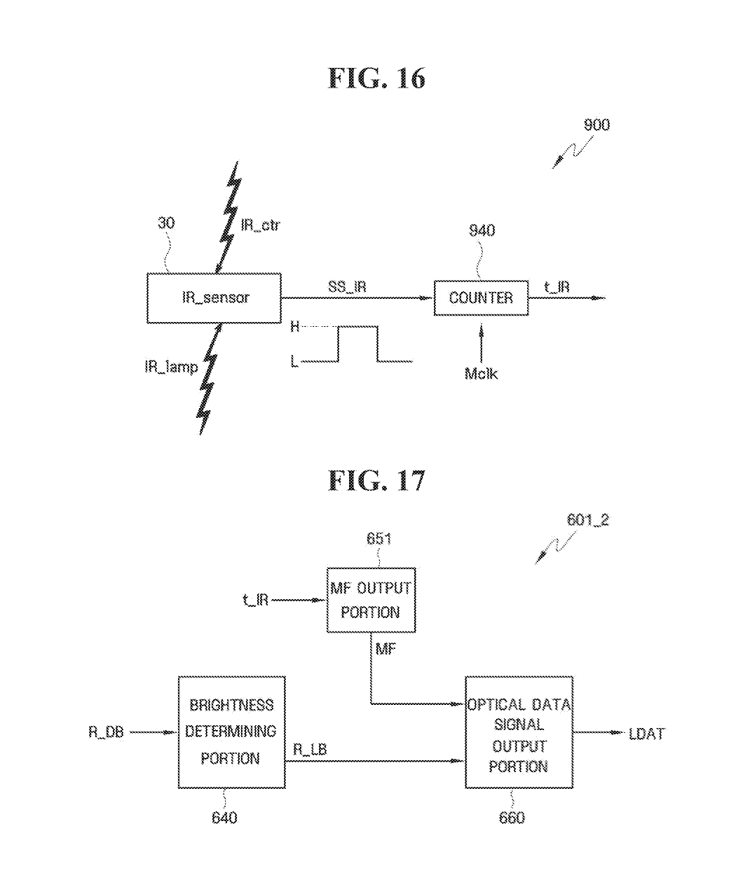

An optical data signal controller 601_2 in the signal control unit 701 and the backlight driver 800 may be mounted on an inverter (not shown). The inverter may be electrically connected with an infrared sensor 30 in the infrared sensing unit 900 in order to adjust a duty ratio of tube current IFL according to the amount of noise, which will be described in more detail later with reference to FIGS. 16 through 18.

A non-display area PA may be an area in which a first substrate (100 in FIG. 3) is wider than a second substrate (200 in FIG. 3) so as not to display an image. The infrared sensing unit 900 may be mounted in the non-display area PA. The infrared sensing unit 900 may measure the length of time t_IR during which infrared light having a wavelength close to a wavelength of infrared control signal IR_ctr is detected and may provide the length of time t_IR to the signal control unit 701. The operation of the infrared sensing unit 900 is described in more detail later with reference to FIG. 16.

The signal control unit 701 may receive first image signals R, G, and B, external control signals Vsync, Hsync, Mclk, and DE for controlling the display of the first image signals R, G, and B and the length of time t_IR to output a second image signal IDAT, a data control signal CONT1, a gate control signal CONT2, and an optical data signal LDAT.

More specifically, the signal control unit 701 may convert the first image signals R, G, and B into the second image signal IDAT and may output the second image signal IDAT. The signal control unit 701 may also receive the length of time t_IR to provide optical data signal LDAT having a duty ratio including transition intervals to the backlight driver 800. A transition interval may denote an interval during which a duty ratio increases from an initial value to a final value. The signal control unit 710 may be functionally divided into the image control signal controller 600_1 and the optical data signal controller 601_2. The operation of the optical data signal controller 601_2 will be described in more detail later with reference to FIG. 17.

FIG. 16 is a block diagram of the infrared sensing unit shown in FIG. 15 in accordance with one or more embodiments.

Referring to FIG. 16, the infrared sensing unit 900 may include the infrared sensor 30 and a counter 940. The infrared sensor 30 may detect an infrared control signal IR_ctr received from the remote controller (50 in FIG. 1) and/or a part of the lamp infrared rays IR_lamp emitted from the fluorescent lamp FL, which have a wavelength close to the wavelength of the infrared control signal IR_ctr, and outputs an infrared sensor signal SS_IR. A high level of the infrared sensor signal SS_IR represents an interval during which the infrared control signal IR_ctr and the lamp infrared ray IR_lamp having a wavelength close to the wavelength of the infrared control signal IR_ctr are detected.

The counter 940 may receive the infrared control signal IR_ctr from the infrared sensor 30 to output the length of time t_IR at an interval during which the infrared control signal IR_ctr is at a high level. Thus, t_IR denotes the length of time during which the infrared control signal IR_ctr or the infrared ray having a wavelength close to the wavelength of the infrared control signal IR_ctr is detected. For example, the counter 940 may use main clock signal Mclk shown in FIG. 15 to output a digital value corresponding to the length of time t1.

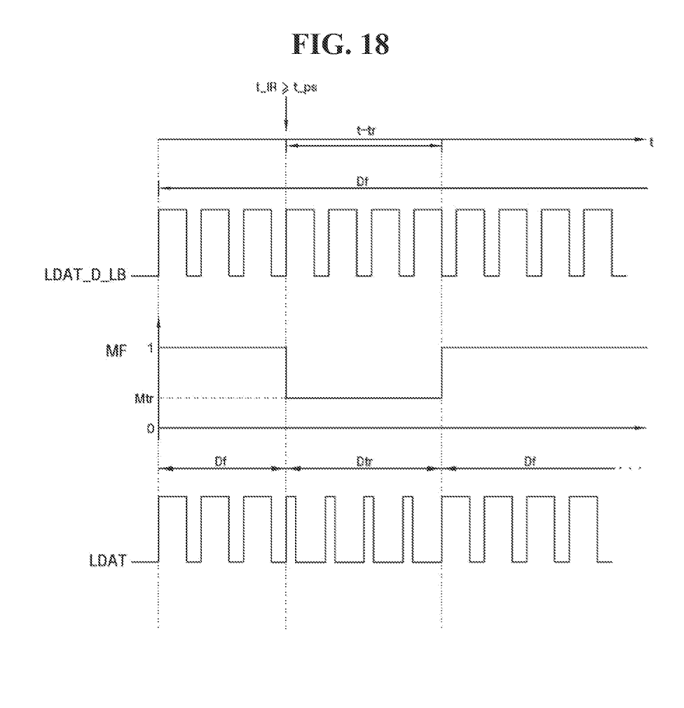

FIG. 17 is a block diagram of the optical data signal controller shown in FIG. 15, and FIG. 18 is a timing diagram for explaining an optical data signal illustrated in FIG. 15 in accordance with one or more embodiments.

Referring to FIGS. 17 and 18, the optical data signal controller 601_2 may include a brightness determining portion 640, a multiplication factor output portion 651, and an optical data signal output portion 660. The multiplication factor output portion 651 receives the length of time t_IR during which infrared light is detected and outputs a multiplication factor MF to be multiplied by a duty ratio corresponding to the native brightness R_LB of a backlight. The multiplication factor MF may be preset by the manufacturer or have a transition value Mtr between 0 and 1 during a transition interval t_tr as shown in FIG. 18. An interval t_tr during which the multiplication factor MF has a transition value Mtr begins at a point where the length of time t_IR is greater than or equal to a preset value t_ps. The optical data signal LDAT may include a transition interval t_tr at which it has a transition duty ratio Dtr.

As illustrated in FIG. 18, the ratio of the transition duty ratio Dtr to the final duty ratio Df may be 10% to 60%, for example, less than 50%. The length of an interval at which the optical data signal LDAT has a transition duty ratio Dtr may be equal to the length of an interval at which the multiplication factor MF has a transition value Mtr. The length of an interval at which tube current IFL has a transition duty ratio Dtr may be greater than 10 seconds, for example, greater than 30 seconds.

As described above, the optical data signal controller 6012 may receive the length of time t_IR during which infrared light is detected and, if the length of time t_IR is greater than or equal to the preset value t_ps, outputs optical data signal LDAT having a transition duty ratio Dtr during a transition interval t_tr that begins at a point where the length of time t_IR may be greater than or equal to the preset value t_ps. The preset value t_ps may denote the length of time during which a user does not continue to press buttons on the remote controller, for example, 10 seconds. The length of the transition interval t_tr may be preset to greater than 10 seconds, for example, greater than 30 seconds.

Upon detection of infrared light having a wavelength close to the wavelength of the infrared control signal IR_ctr for more than the preset value t_ps, e.g., more than 10 seconds, the data signal controller 6012 may determine that noise has been generated and outputs a tube current IFL having a transition duty ratio D_tr that may be decreased from a final duty ratio Df during the transition interval t_tr. For example, the duty ratio of the tube current IFL may be decreased to the transition duty ratio D_tr, e.g., greater than 10 or 30 seconds and restored to the final duty ratio Df.

Thus, the amount of tube current IFL may be decreased at an interval during which the optical data signal LDAT has a transition value Mtr. This may reduce the amount of energy emitted during vaporization of Ar within the fluorescent lamp FL, thereby reducing the amount of energy that will be converted into lamp infrared ray IR_lamp due to failure to absorb the energy as Hg vaporizes.

As described above, the LCD 11 in accordance with one or more embodiments may be configured to adjust a duty ratio of the tube current IFL being applied to the fluorescent lamp FL according to the amount of noise detected by the infrared sensor 30.

More specifically, upon sensing infrared light having a wavelength close to the wavelength of the infrared control signal IR_ctr for more than the preset value t_ps, the LCD 11 may recognize the detected infrared light as noise. For example, when infrared light having a wavelength close to the wavelength of the infrared control signal IR_ctr is detected for more than 10 seconds, the infrared light may be recognized as noise.

As described above, the LCD 11 according to the present embodiment may be configured to reduce the amount of lamp infrared ray IR_lamp emitted from the fluorescent lamp FL by decreasing the amount of tube current IFL during the transition interval t_tr if the amount of noise increases as a result of detecting the amount of lamp infrared ray IR_lamp in real time, thereby reducing the malfunction of the remote controller due to an increase in the amount of lamp infrared ray IR_lamp emitted. The LCD 11 also eliminates the need for a separate noise sensor by using the infrared sensor 30 as a noise sensor that detects noise emitted by the fluorescent lamp FL, which may reduce manufacturing costs.

While embodiments of the present disclosure have been particularly shown and described with reference to example embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A liquid crystal display (LCD) comprising:
an LCD panel on which an image is displayed; and
a fluorescent lamp providing light to the LCD panel,
wherein a tube current having a duty ratio is applied to the fluorescent lamp, wherein the duty ratio of the tube current increases gradually from an initial duty ratio to a final duty ratio during a transition interval.

2. The LCD of claim 1, wherein operation of the LCD panel is controlled by an infrared control signal received from an external circuit.

3. The LCD of claim 1, wherein the duty ratio of the tube current increases stepwise during the transition interval.

4. The LCD of claim 1, wherein a ratio of the initial duty ratio to the final duty ratio is in a range from about 10% to about 60%.

5. The LCD of claim 1, wherein the duty ratio of the tube current increases from the initial duty ratio to the final duty ratio over a time period greater than 10 seconds.

6. The LCD of claim 1, wherein the duty ratio of the tube current increases stepwise during the transition interval over a time period greater than 10 seconds and a ratio of the initial duty ratio to the final duty ratio is in a range from about 10% to about 60%.

7. The LCD of claim 1, wherein the duty ratio of the tube current increases continuously and steadily.

8. The LCD of claim 1, wherein the fluorescent lamp is a CCFL (Cold Cathode Fluorescent Lamp).

9. The LCD of claim 8, wherein the CCFL is a low-pressure lamp, and wherein the amount of emitted lamp infrared ray containing a wavelength coincident with a wavelength of the infrared control signal increases as the percentage of argon within the low-pressure lamp increases.

10. The LCD of claim 1, wherein the fluorescent lamp is filled with mercury and argon, and wherein the duty ratio of the tube current increases as the amount of mercury vaporized increases.

11. The LCD of claim 1, wherein the duty ratio of the tube current increases with increasing temperature of the fluorescent lamp.

12. A liquid crystal display (LCD) comprising:
an infrared sensor adapted to detect an infrared control signal received from an external circuit;
an LCD panel on which an image is displayed; and
a fluorescent lamp providing light to the LCD panel,
wherein a duty ratio of tube current being applied to the fluorescent lamp is adjusted according to an amount of noise detected by the infrared sensor.

13. The LCD of claim 12, further comprising an inverter that electrically connects with the infrared sensor and adjusts the duty ratio according to the amount of noise.

14. The LCD of claim 12, wherein upon detection of infrared light having a wavelength close to a wavelength of the infrared control signal for more than a preset duration of time, the tube current applied to the fluorescent lamp has a transition duty ratio that is less than a final duty ratio for more than the preset duration of time.

15. The LCD of claim 14, wherein upon detection of infrared light having a wavelength close to the wavelength of the infrared control signal for more than 10 seconds, the tube current applied to the infrared lamp has a duty ratio that is less than the final duty ratio.

16. The LCD of claim 14, wherein the tube current applied to the fluorescent lamp has a duty ratio that is less than the final duty ratio for more than 30 seconds, followed by application of the tube current having the final duty ratio.

17. A liquid crystal display (LCD) comprising:
an infrared sensor adapted to detect an infrared control signal received from an external circuit;
an LCD panel on which an image is displayed; and
a fluorescent lamp providing light to the LCD panel,
wherein upon detection of infrared light having a wavelength close to a wavelength of the infrared control signal for more than a preset duration of time, the detected infrared light is recognized as noise.

18. The LCD of claim 17, wherein the wavelength of the infrared light is close to 900 nm.

19. The LCD of claim 17, wherein upon detection of the noise, tube current having a transition duty ratio that is less than a final duty ratio is applied to the fluorescent lamp for more than 10 seconds.

20. The LCD of claim 17, wherein upon detection of the infrared light having the wavelength close to the wavelength of the infrared control signal for more than 10 seconds, the detected infrared light is recognized as noise.
